(19) United States
(12) Patent Application Publication
(10) Pub. No.: US 2012/0278754 A1
(43) Pub. Date: Nov. 1, 2012

(54) Elastic Over-Scroll

(75) Inventors: Daniel Lehmann, Mountain View, CA (US); Gabriel Cohen, Alameda, CA (US)

(73) Assignee: Google Inc., Mountain View, CA (US)

(21) Appl. No.: 13/097,983

(22) Filed: Apr. 29, 2011

(51) Int. Cl. G06F 3/14

(52) U.S. Cl. 715/784

(57) ABSTRACT

Embodiments provide exemplary methods and systems for implementing an elastic over-scroll. An exemplary method includes displaying, on a display device, a list of items including a first item located at a first position and a second item located at a second position. The exemplary method also includes identifying an end of the list at the first position, and detecting an object associated with a movement in a first direction toward the first item. The method further includes increasing a distance between the first item and the second item while maintaining the display of the first item at the first position, based on the detecting.

### BACKGROUND

1. Field

Embodiments relate to over-scrolling.

2. Background Art

Display systems play a prominent role in the design of many electronic devices. For example, notebook computers, personal digital assistants (PDAs), satellite navigation devices, electronic book readers, and mobile phones each provide a display device for presenting content to a user. Display systems may display lists to a user. Typically, when a user scrolls to an end of a list, the display system does not indicate to a user that an end of the list has been reached.

### BRIEF SUMMARY

A user may view a list of items on an electronic device. The electronic device may accept input from a user to view different portions of the list. When a user reaches an end of the list (e.g., first item or last item of the list), the user may continue attempting to scroll farther because there is no indication on the display that an end of the list has been reached. It may be beneficial to indicate to a user that an end of the list has been reached.

Embodiments include a method for over-scrolling a list. The method includes displaying, on a display device, a list of items including a first item located at a first position and a second item located at a second position. The method also includes identifying an end of the list at the first position, and detecting an object associated with a movement in a first direction toward the first item. The method further includes increasing a distance between the first item and the second item while maintaining the display of the first item at the first position, based on the detecting.

In one embodiment, increasing a distance between the first item and the second item includes moving the second item to a third position on the display. The distance between the first item and the second item increases proportionally to the movement in the first direction. The method may also include determining that the object is not detected on the display device, and displaying the first item at the first position and the second item at the second position. The object associated with the movement is a finger or a pointing device. The list of items includes at least one of a block of text, lines of text, or images.

In one embodiment, the displayed list of items includes a third item located at a third position adjacent to the second position. The method includes increasing a distance between the second item and the third item while maintaining the display of the first item at the first position, based on detecting an object associated with a movement in a first direction toward the first item. In one embodiment, the distance between the first item and the second item is the same as the distance between the second item and the third item. In another embodiment, the distance between the first item and the second item is different from the distance between the second item and the third item. The first position is located at a beginning or end of the list.

Embodiments further include a system for over-scrolling a list. The system includes a display configured to display a list of items including a first item located at a first position and a second item located at a second position. The system also includes an identifier configured to identify an end of the list at the first position, and a sensor configured to detect an object associated with a movement in a first direction toward the first item. The system further includes an input device configured to increase a distance between the first item and the second item while maintaining the display of the first item at the first position, based on the detecting.

Embodiments additionally include a computer program product that includes a computer-usable medium with computer program logic recorded thereon for enabling a processor to over-scroll. The computer program logic includes the following: first computer readable program code that displays, on a display device, a list of items including a first item located at a first position and a second item located at a second position; second computer readable program code that identifies an end of the list at the first position; third computer readable program code that detects an object associated with a movement in a first direction toward the first item; and fourth computer readable program code that increases a distance between the first item and the second item while maintaining the display of the first item at the first position, based on the detecting.

Further features and advantages of embodiments described herein, as well as the structure and operation of various embodiments, are described in detail below with reference to the accompanying drawings. It is noted that the embodiments described below are not limited to the specific embodiments described herein. Such embodiments are presented herein for illustrative purposes only. Additional embodiments will be apparent to persons skilled in the relevant art based on the teachings contained herein.

### BRIEF DESCRIPTION OF THE DRAWINGS/FIGS.

The accompanying drawings, which are incorporated herein and form a part of the specification, illustrate embodiments and, together with the description, further serve to explain the principles herein and to enable a person skilled in the relevant art to make and use the embodiments described herein.

FIG. 1 shows an exemplary computer system in which embodiments described herein can be implemented.

FIGS. 2A-2D show an illustration of an elastic over-scroll associated with a component list, according to an embodiment.

FIGS. 3A-3D show an illustration of an elastic over-scroll associated with long form text, according to an embodiment.

FIGS. 4A-4B show an illustration of an elastic over-scroll, according to an embodiment.

FIGS. 5A-5B show an illustration of an elastic over-scroll with a block of text, according to an embodiment.

FIG. 6 shows an exemplary method of using an elastic over-scroll, according to an embodiment.

FIG. 7 shows an example computer system in which embodiments can be implemented.

### DETAILED DESCRIPTION

The following detailed description refers to the accompanying drawings that illustrate exemplary embodiments. Other embodiments are possible, and modifications can be made to the embodiments within the spirit and scope of the detailed description.

It would be apparent to one of skill in the relevant art that the embodiments, as described below, can be implemented in many different embodiments of software, hardware, firmware, and/or the entities illustrated in the figures. Any actual software code with the specialized control of hardware to implement embodiments is not limiting of the detailed description. Thus, the operational behavior of embodiments will be described with the understanding that modifications and variations of the embodiments are possible, given the level of detail presented herein.

In the detailed description of embodiments that follows, references to “one embodiment”, “an embodiment”, “an example embodiment”, etc., indicate that the embodiment described, among others, may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

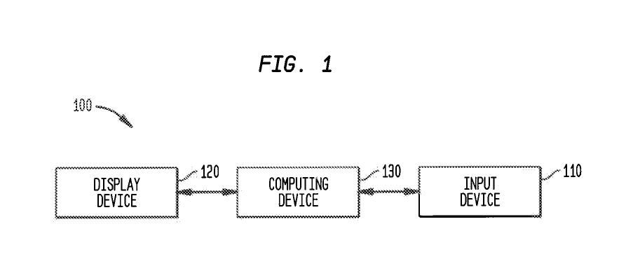

FIG. 1 shows an exemplary computer system in which embodiments described herein can be implemented. Computer system 100 can be, for example and without limitation, a personal computer system (e.g., desktop, laptop, tablet, and handheld computers), a personal digital assistant, a mobile device, a consumer electronic device, and other similar types of electronic devices. Computer system 100 includes an input device 110, a display device 120, and a computing device 130.

In an embodiment, computing device 130 is configured to execute instructions and to carry out operations associated with computer system 100. Computing device 130 can control the reception and manipulation of input and output data from input device 110 and display device 120, according to an embodiment. In an embodiment, computing device 130 can be implemented on a single computing device such as, for example and without limitation, a stand-alone device. Examples of computing device 130 include, but are not limited to, a central processing unit, an application-specific integrated circuit, and other types of computing devices that have at least one processor and memory. In another embodiment, computing device 130 can have multiple processors and multiple shared or separate memory components such as, for example and without limitation, one or more computing devices incorporated in a clustered computing environment or a server farm. The computing process performed by the clustered computing environment, or server farm, may be carried out across multiple processors located at the same or different locations.

In reference to FIG. 1, display device 120 is operatively coupled to computing device 130. Display device 120 can be, for example and without limitation, a liquid crystal display, a plasma display, a computer monitor (e.g., a variable graphics array (VGA) display, a super VGA display, and a cathode ray tube display), OLED (organic light emitting diode), AMOLED (active matrix organic light emitting diode), and other similar types of display devices. In an embodiment, display device 120 can be configured to display a graphical user interface (GUI) that provides an interface between a user and computer system 100 or an application running on computer system 100 (also referred to herein as a “system application”). The system application can be, for example and without limitation, an email application or a video game. Features of the GUI for the system application can be arranged in a predefined layout on display device 120 or can be generated dynamically to serve specific actions taken by the user, according to an embodiment. For instance, the GUI can display information such as interactive text and graphics for the user to select via input device 110.

Display device 120 may display a variety of content. For example, display device 120 may display content such as contact information, text, images, e-mail messages, and documents. Content displayed on display device 120 may also include a list of items that a user can view and scroll. The list of items can be distinguishable (e.g., names in a contact list or lines in a document). The list of items may include a first item located at a first position and a second item located at a second position.

Input device 110 is also operatively coupled to computing device 130. In an embodiment, the user can make a selection on the GUI for the system application via input device 110. Input device 110 can include a touch sensing device configured to receive an input from a user's touch or a touch gesture from an external touch device (e.g., stylus device) and send the touch information to computing device 130, according to an embodiment. In turn, computing device 130 executes an operation associated with the touch information. The touch sensing device can be, for example and without limitation, a capacitive sensing device, a resistive sensing device, a surface acoustic wave sensing device, a pressure sensing device, an optical sensing device, and other similar types of sensing devices. In one embodiment, input device 110 can be presence sensitive and not require a touch, in addition to or instead of being a touch sensitive device.

In an embodiment, input device 110 can include a touch screen device integrated with a display device 120. The touch screen device can be integrated with display device 120, or it may be a separate component device from display device 120, according to an embodiment. In positioning the touch screen device over or in front of display device 120, the user can manipulate the GUI for the system application via one or more touch gestures (e.g., finger gestures or an external touch device) applied to input device 110. For instance, the user can press a button displayed by the GUI or drag an object in the system application from one end to another end of display device 120 using finger gestures or an external touch device.

Input device 110, display device 120, and computing device 130 of computer system 100 are shown in FIG. 1 as separate units, operatively coupled together. Two or more of the devices of computer system 100 may be provided in an integrated unit. For example, input device 110, display device 120, and computing device 130 can all be part of a smart phone, with the smart phone including an on-board processor serving as the processor for computing device 130 and a flat-screen display with an overlaying touch screen serving as display device 120 and input devices 110.

Electronic devices may display a list of items to a user. The user can perform acts to view different portions of the list (e.g., scrolling up, down, left, right) on display device 120. Further, a user can scroll a list in several directions at the same time (e.g., to the left and top, to the right and bottom, etc.). When a user reaches an end of the list, the user may continue attempting to scroll further because the display device 120 has not given any indication to the user that an end of the list has been reached. Indicating to the user that an end of the list has been reached may make the user's experience more enjoyable.

Embodiments provide an indication to a user that the user has reached an end of a displayed list. For example, the user may be visually informed that an end of a list has been reached. In one embodiment, to indicate to a user that the end of the list has been reached, items in the list separate from each other. For example, a distance between the first item and the second item may increase while maintaining the display of the first item at the first position.

In an embodiment, a list of items is displayed. The list of items includes at least two items. The list of items may include separable items or distinct items (e.g., names in a contact list, grocery list, etc). The list may include a first item located at a first position and a second item located at a second position. The first item may be before, after, or adjacent to the second item in the list. In an embodiment, an end of the list is identified at the first position. An item at an end of a list may be the first item of the list or the last item of the list.

An object associated with a movement in a first direction toward the first item may be detected. The object can include a user's finger. The direction can be upward or downward, left or right, or a combination of these directions. For example, a user may drag her finger in a direction toward the first item. If the first item is not yet displayed on display device 120, the list may continue to scroll and the items of the list may be displayed at different locations on display device 120. When this occurs, the user may see different portions of the list. When the user reaches the end of the list, the first item may be displayed on display device 120. When a user attempts to scroll farther in the list, display device 120 may visually indicate to a user that an end of the list has been reached. Based on the user's movement, the items in the list may separate from each other. In an embodiment, a distance between the first item and the second item may be increased while maintaining the display of the first item at its initial position, as will be described in further detail below.

Other combinations of the functional components of FIG. 1 are also possible, as would be known to a person of skill in the art. Alternative embodiments may include more components than the components shown in FIG. 1. For example, in one embodiment, system 100 includes an end-of-list identifier to identify an end of a list. The identifier may identify more than one end of a list (e.g., the first and last items of the list).

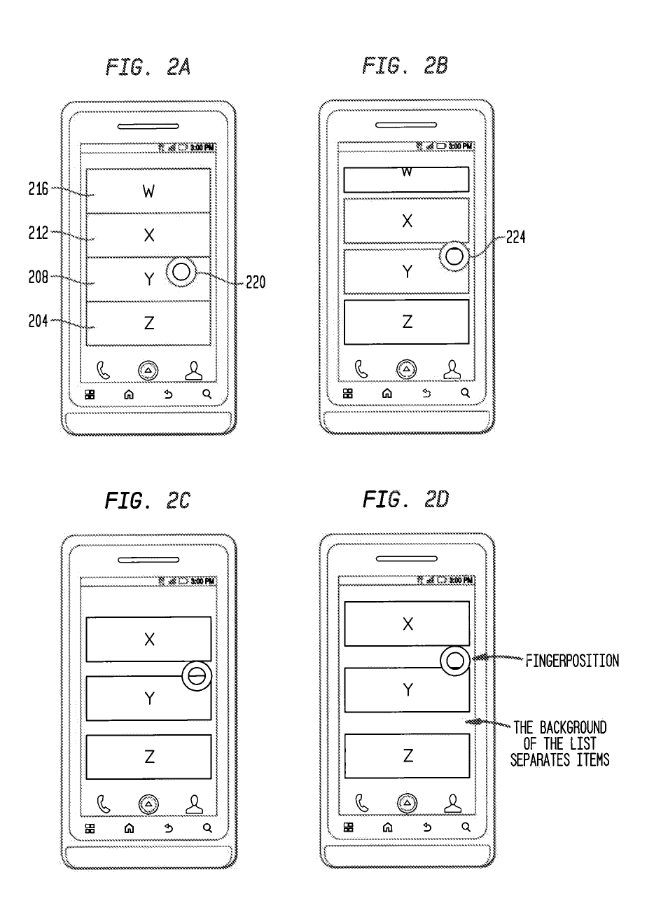

FIGS. 2A-2D show an illustration of an elastic over-scroll associated with a component list, according to an embodiment. FIG. 2A shows a list of items that includes a first item Z 204 located at a first position, a second item Y 208 located at a second position, a third item X 212 located at a third position, and a fourth item W 216 located at a fourth position. Second item Y 208 is adjacent to first item Z 204 and third item X 212. Fourth item W 216 is adjacent to third item X 212.

The list of items can be displayed on a display such as display device 120. In

FIG. 2A, first item Z 204 can be at an end of the list. System 100 may include a component that identifies an end of the list, according to an embodiment. For example, an end-of-list identifier may identify first item Z 204 as being at one end of the list.

An object associated with a movement may be detected. In an example, input device 110 is a touch screen and the user touches near or on the surface such that input device 110 understands and accepts the finger movements. A user may have her finger located at position 220 such that input device 110 understands and accepts the finger movements. Input device 110 may detect an object associated with a movement and display device 120 may display the list of items based on the detection.

In this example, the user may continue to continue to drag her finger toward an end of the list (e.g., first item Z 204). When the user scrolls to an end of the list, the user may not be aware that an end of the list has been reached. The user may continue to attempt to scroll past the end of the list by dragging her finger toward first item Z 204.

Display device 120 may visually indicate to a user that an end of the list has been reached. Based on detecting the object associated with a movement in a direction away from first item Z 204, which causes the display of the list to scroll towards the bottom, items in the list may be spaced farther apart when the bottom end of the list is reached. A distance between the first item and the second item may be increased while maintaining the display of the first item at the first position. In an example, when a user has her finger near position 220 and moves her finger away from first item Z 204 toward position 224 (FIG. 2B), items of the list may separate. The item at an end of the list may remain in its original position.

Alternatively, the user may move her finger from position 220 toward first item Z 204 in order to scroll the list. In response, the items in the list may be separated to indicate that the last item in the list is displayed and the list cannot be scrolled further. The last item in the list may remain its original position.

FIG. 2B shows an increased distance between the list of items. In FIG. 2B, first item Z 204 remains located at a first position. When the distance between the first item and the second item is increased, the second item is moved to a different position from its initial position (e.g., the second position). Third item X 212 is located at a different position from its initial position (e.g., a third position), and fourth item W 216 is located at a different position from its initial position (e.g., a fourth position). In one embodiment, display device 120 may display the list of items and input device 110 may detect an object associated with a movement associated with a scrolling operation toward an end of the list (e.g., first item Z 204).

A background may be distinguished from the list of items. The background may appear on display device 120 to show the items as separated items. In some embodiments, items in the list may continue to separate a farther distance from each other in different situations. For example, items in the list may continue to separate a farther distance from each other when a user continues to leave her finger at a particular position (e.g., position 220). As the user leaves her finger at or near for example position 220, the list of items may separate from each other even farther and continue to do so until the user releases her finger or a maximum distance between the items is reached.

FIGS. 2C-2D show increased distances between the list of items. A distance between list item Z and list item Y in FIG. 2C is greater than a distance between list item Z and list item Y in FIG. 2B. A distance between list item Z and list item Y in FIG. 2D is greater than a distance between list item Z and list item Y in FIG. 2C. In FIGS. 2B-2D, second item Y 208, third item X 212, and fourth item W 216 are located at different positions from their initial positions in FIG. 2A. In FIGS. 2B-2D, first item Z 204 remains at the same position from its initial position in FIG. 2A.

In one embodiment, items in the list may continue to separate a farther distance from each other depending on the speed of the detected movement. For example, a distance between the items may increase proportionally to the detected movement of the object. For example, a user may drag her finger on display device 120 at a first speed toward first list item Z. FIG. 2B may display a list of separated items that may be displayed in response to this movement. A user may drag her finger on display device 120 at a second speed toward first list item Z. The second speed may be greater than the first speed. FIG. 2C may display a list of separated items that may be displayed in response to this movement. A distance between each list of items is greater in FIG. 2C than in FIG. 2B. Similarly, a user may drag her finger on display device 120 at a third speed toward first list item Z. The third speed may be greater than the second speed (e.g., done in a rapid swipe). FIG. 2D displays a list of separated items that may be displayed in response to this movement. A distance between each list of items is greater in FIG. 2D than in FIG. 2C. As the speed of the detected movement increases, the distances between the items in the list may also increase. The distance between the items in the list may vary according to the variable speed with which a user drags her finger, according to an embodiment.

In one embodiment, items in the list may continue to separate a farther distance from each other when the user continues to move her finger as part of the scrolling gesture. In another embodiment, items in the list may continue to separate a farther distance from each other depending on how many items are in the list. In an example, when more items are in a list, the distance between items may be less than when fewer items are in the list. A user may prefer this to occur when she would like to see as much of the list as possible on display device 120. For example, in FIG. 2A, fourth item W 216 may be visible on display device 120. As the items separate from each other, as shown in FIG. 2B, item W becomes partially visible on display device 120. As the items separate even farther from each other, as shown in FIG. 2C, item W is no longer visible on display device 120.

When the object is no longer detected, the distance between the first item and the second item can be decreased. For example, when a user releases her finger while the items of the list are separated or stretched, a distance between the first item and the second item can be decreased. The items may be restored back to their initial positions. For example, second item Y 208 may revert to being located at the second position, third item X 212 may revert to being located at the third position, and fourth item W 216 may revert to being located at the fourth position.

In some embodiments, the speed at which items snap back may vary depending on different factors. For example, in one embodiment, the speed at which items snap back varies according to how fast a user is scrolling the list. In another embodiment, the speed at which items snap back varies according to the density of the underlying data. In some embodiments, a snap back can occur when the finger is released or after a given time delay from when the finger is released. In one embodiment, the time delay can be constant (e.g., five seconds), or can depend on the amount of over-scrolling (e.g., how far or how fast the finger has scrolled). The snap back speed can be linear, accelerated, decelerated, or any other velocity curve. The snap back can also have a bounce effect. For example, the snap back of the items in the list may appear similar to a spring that has been stretched and released.

In some embodiments, the object associated with the movement can be a finger or pointing device. Other input devices may also include a trackball, touchpad, wheel, or slider.

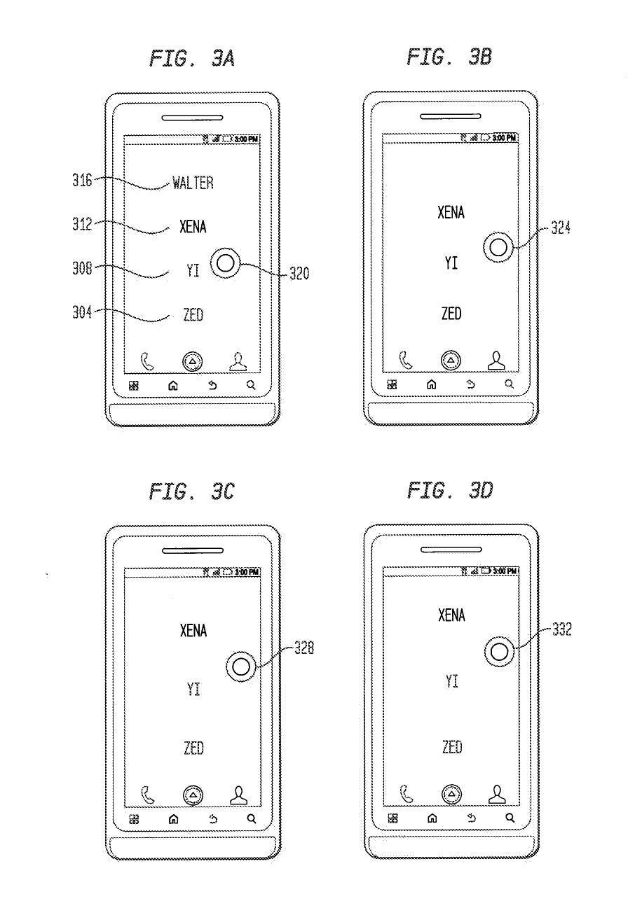

The list of items may include various components or items such as a block of text, lines of text, or images. FIGS. 3A-3D show an illustration of an elastic over-scroll associated with long form text, according to an embodiment. FIG. 3A shows a list of items that includes a first item Zed 304 located at a first position, a second item Yi 308 located at a second position, a third item Xena 312 located at a third position, and a fourth item Walter 316 located at a fourth position. The list of items can be displayed on a display such as display device 120. In FIG. 3A, first item Zed 304 can be at an end of the list. As shown in FIGS. 3A-3D, the list of text items can separate.

As described above, distances between the items can increase if a condition is met. A display device 120 may display the text items moving apart from each other. For example, a user may place her finger near an end of a list at position 320. A movement of the user's finger may be detected and the items in the list may be separated to indicate to a user that an end of the list is displayed. FIG. 3B shows when the user's finger moves from position 320 to position 324, the items in the list are separated. FIG. 3C shows when the user's finger moves to position 328, the items in the list continue to separate. FIG. 3D shows when the user's finger moves to position 332, the items in the list continue to separate even farther from each other. In an embodiment, a user can see the items moving on display device 120.

Items of a list may be manipulated in a variety of ways. For example, the items of the list may be manipulated to stretch, move, or compress vertically, horizontally, or diagonally. Further, items can be separated at different distances from each other. For example, different spacing may be shown between first and second items than is shown between third and fourth items.

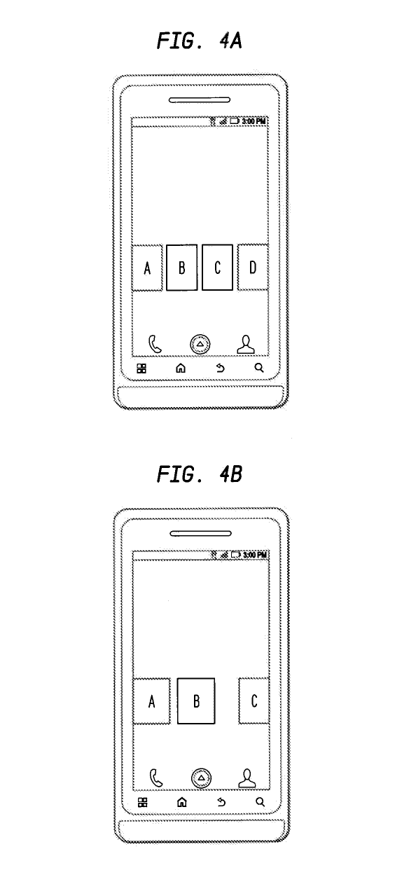

FIGS. 4A-4B show an illustration of an elastic over-scroll, according to an embodiment. FIG. 4A shows a list of items that include item A, item B, item C, and item D. As a user moves her finger in a direction to perform a scroll function (e.g., an end of the list, to the right, or in another direction), a distance between items A, B, C, and D may increase while maintaining the display of item A in its initial position. FIG. 4B shows a distance between items A and B. The distance between items A and B in FIG. 4B is greater than the distance between items A and B in FIG. 4A.

Additionally, the distance between items B and C in FIG. 4B is greater than the distance between items B and C in FIG. 4A. The distance between items A and C in FIG. 4B is greater than the distance between items A and C in FIG. 4A. In FIG. 4B, the distance between items A and B is not the same as the distance between items B and C. The distance between items B and C is greater than the distance between items A and B. In an embodiment, as the distances between items A, B, C, and D increase, display device 120 shows items B, C, and D moving to different positions on the display. Items in the list may no longer be visible due to the separation of items (e.g., item D) and may scroll off the display. This movement may be aesthetically pleasing to a user, and intuitively indicate that the end of the list has been reached.

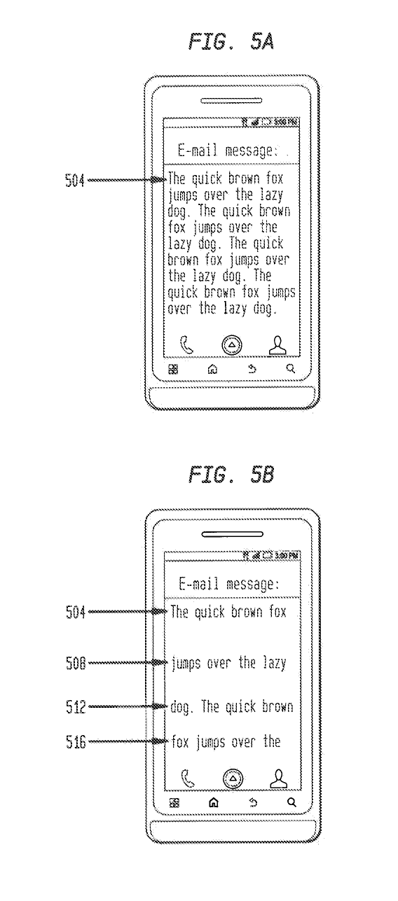

FIGS. 5A-5B show an illustration of an elastic over-scroll with a block of text, according to an embodiment. The block of text can be text from for example an email message, web site, or other document. In FIG. 5A, the block of text shows a list of items that includes lines of text. Each line of text can be moved apart from each other.

An end of the list of items may be a line at position 504. When a user drags her finger to scroll toward the end of the list, lines of the text may separate. FIG. 5B shows a display that may appear on display device 120 when input device 110 detects an object associated with a movement in a direction to scroll toward the end of the list. In FIG. 5B, a distance between the second line at position 508 and the first line at position 504 is increased. Distances between the third line at position 512 and the first and second lines are increased. Distances between the fourth line at position 516 and the first, second, and third lines are also increased.

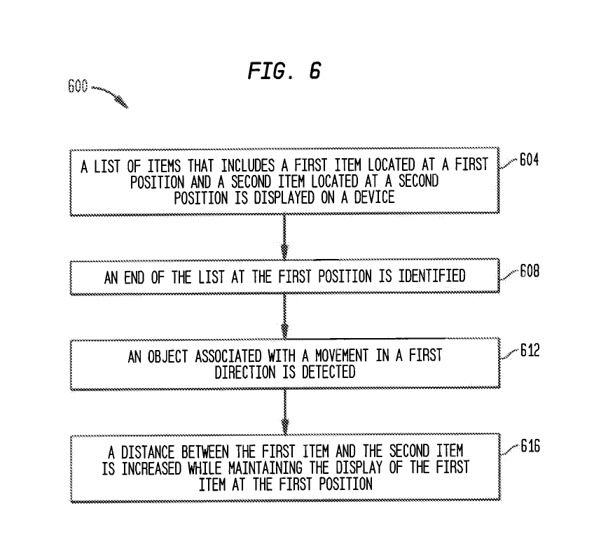

FIG. 6 shows an exemplary method 600 of using an elastic over-scroll, according to an embodiment. For ease of explanation, method 600 will be described in the context of a mobile phone. Based on the description herein, a person of ordinary skill in the relevant art will recognize that method 600 can be executed on other types of devices such as, for example and without limitation, a PDA and a laptop. These other types of devices are within the scope and spirit of the embodiments described herein.

While method 600 is described with respect to an embodiment, method 600 is not meant to be limiting and may be used in other applications. In an example, method 600 may be used to display separated items of a list, like in system 100 of FIG. 1. However, method 600 is not meant to be limited to system 100.

At step 604, a list of items is displayed on a mobile phone. The list of items may include a first item located at a first position and a second item located at a second position. In some embodiments, display device 120 may perform this step. At step 608, an end of the list is identified. In some embodiments, an end identifier may perform this step. The end of the list may be at the first position. The first position may be located at a beginning or end of the list.

At step 612, an object associated with a movement in a first direction is detected. In some embodiments, input device 110 may perform this step. At step 616, a distance between the first item and the second item is increased while maintaining the display of the first item at the first position. In some embodiments, display device 120 may perform this step. For example, input device 110 may detect an object associated with a movement toward the end of the list. Based on the detected movement, the display device may display an increased distance between the first item and the second item while maintaining the display of the first item at its initial position.

Operations for the above-described embodiments may be further described with reference to one or more logic flows. It may be appreciated that the representative logic flows do not necessarily have to be executed in the order presented, or in any particular order, unless otherwise indicated. Moreover, various activities described with respect to the logic flows can be executed in serial or parallel fashion. The logic flows may be implemented using one or more hardware elements and/or software elements of the described embodiments or alternative elements as desired for a given set of design and performance constraints. For example, the logic flows may be implemented as logic (e.g., computer program instructions) for execution by a logic device (e.g., a general-purpose or specific-purpose computer).

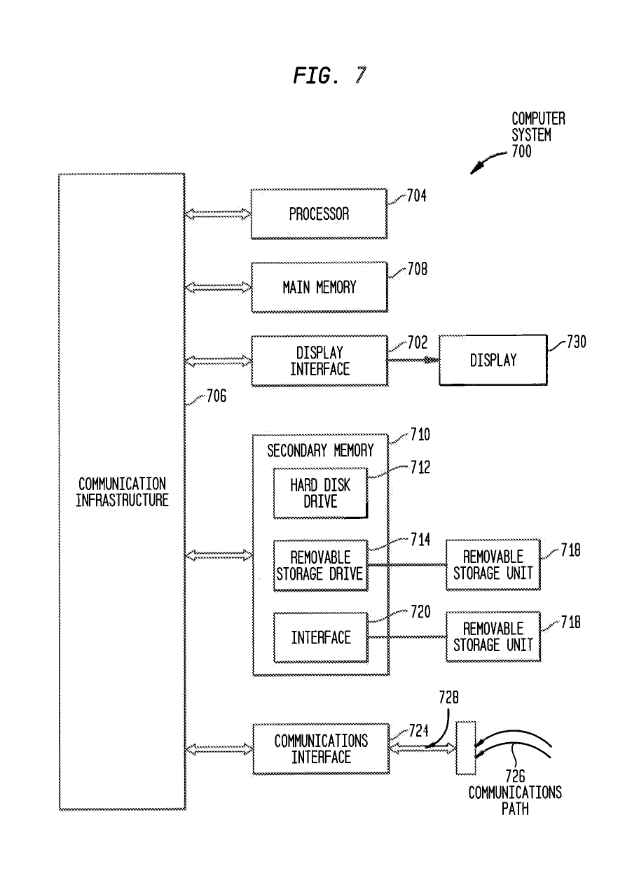

FIG. 7 shows an example computer system in which embodiments can be implemented. Various aspects of the embodiments described herein may be implemented in software, firmware, hardware, or a combination thereof. The methods illustrated by exemplary method 600 of FIG. 6 can be implemented in system 100. Various embodiments are described in terms of this example. After reading this description, it will become apparent to a person skilled in the relevant art how to implement embodiments described herein using other computer systems and/or computer architectures.

In an embodiment, system 100 includes one or more processors, such as processor 704. Processor 704 may be a special purpose or a general-purpose processor. Processor 704 is connected to a communication infrastructure 706 (e.g., a bus or network)

System 100 may also include a main memory 708, preferably random access memory (RAM), and may also include a secondary memory 710. Secondary memory 710 can include, for example, a hard disk drive 712, a removable storage drive 714, and/or a memory stick. Removable storage drive 714 can comprise a floppy disk drive, a magnetic tape drive, an optical disk drive, a flash memory, or the like. The removable storage drive 714 reads from and/or writes to a removable storage unit 718 in a well-known manner. Removable storage unit 718 can include a floppy disk, magnetic tape, optical disk, etc. which is read by and written to by removable storage drive 714. As will be appreciated by persons skilled in the relevant art, removable storage unit 718 includes a computer-readable storage medium having stored therein computer software and/or data.

In alternative implementations, secondary memory 710 can include other similar devices for allowing computer programs or other instructions to be loaded into system 100. Such devices can include, for example, a removable storage unit 722 and an interface 720. Examples of such devices can include a program cartridge and cartridge interface (such as those found in video game devices), a removable memory chip (e.g., EPROM or PROM) and associated socket, and other removable storage units 722 and interfaces 720 which allow software and data to be transferred from the removable storage unit 722 to computer system 100.

System 100 can also include a communications interface 724.

Communications interface 724 allows software and data to be transferred between computer system 100 and external devices. Communications interface 724 can include a modem, a network interface (such as an Ethernet card), a communications port, a PCMCIA slot and card, or the like. Software and data transferred via communications interface 724 are in the form of signals, which may be electronic, electromagnetic, optical, or other signals capable of being received by communications interface 724. These signals are provided to communications interface 724 via a communications path 726. Communications path 726 carries signals and may be implemented using wire or cable, fiber optics, a phone line, a cellular phone link, a RF link or other communications channels.

In this document, the terms “computer program medium” and “computer-readable medium” are used to generally refer to media such as removable storage unit 718, removable storage unit 722, and a hard disk installed in hard disk drive 712. Computer program medium and computer-readable medium can also refer to memories, such as main memory 708 and secondary memory 710, which can be memory semiconductors (e.g., DRAMs, etc.). These computer program products provide software to computer system 100.

Computer programs (also called computer control logic) are stored in main memory 708 and/or secondary memory 710. Computer programs may also be received via communications interface 724. Such computer programs, when executed, enable computer system 100 to implement embodiments described herein. In particular, the computer programs, when executed, enable processor 704 to implement processes described herein, such as the steps in the methods 600 of FIG. 6, discussed above. Accordingly, such computer programs represent controllers of computer system 100. Where embodiments are implemented using software, the software can be stored in a computer program product and loaded into computer system 100 using removable storage drive 714, interface 720, hard drive 712 or communications interface 724.

Based on the description herein, a person skilled in the relevant art will recognize that the computer programs, when executed, can enable one or more processors to implement processes described above, such as the steps in exemplary method 600 illustrated by the exemplary method of FIG. 6. The one or more processors can be part of a computing device incorporated in a clustered computing environment or server farm. Further, the computing process performed by the clustered computing environment such as, for example, the steps in method 600 may be carried out across multiple processors located at the same or different locations.

Embodiments are also directed to computer program products including software stored on any computer-readable medium. Such software, when executed in one or more data processing device, causes a data processing device(s) to operate as described herein. Embodiments employ any computer-usable or -readable medium, known now or in the future. Examples of non-transitory computer-readable mediums include, but are not limited to, primary storage devices (e.g., any type of random access memory), secondary storage devices (e.g., hard drives, floppy disks, CD ROMS, ZIP disks, tapes, magnetic storage devices, optical storage devices, MEMS, nanotechnological storage devices, etc.). Additional examples of computer readable mediums include communication mediums (e.g., wired and wireless communications networks, local area networks, wide area networks, intranets, etc.).

For example, a computer program product may include a computer-readable medium having computer program logic recorded thereon. The computer program logic may be for enabling a processor to execute operations on a computer system to carry out operations of exemplary method 600 described herein. For example, the computer program logic may include first computer readable program code that enables a processor to execute methods according to embodiments.

The computer logic may include: first computer readable program code that enables a processor to display a list of items including a first item located at a first position and a second item located at a second position; second computer readable program code that enables a processor to identify an end of the list at the first position; third computer readable program code that enables a processor to detect an object associated with a movement in a first direction toward the first item; and fourth computer readable program code that enables a processor to increase a distance between the first item and the second item while maintaining the display of the first item at the first position, based on the detecting.

### Conclusion

Embodiments may be implemented in hardware, software, firmware, or a combination thereof. Embodiments may be implemented via a set of programs running in parallel on multiple machines.

The summary and abstract sections may set forth one or more but not all exemplary embodiments of the present invention as contemplated by the inventor(s), and thus, are not intended to limit the present invention and the appended claims in any way.

Embodiments of the present invention have been described above with the aid of functional building blocks illustrating the implementation of specified functions and relationships thereof. The boundaries of these functional building blocks have been arbitrarily defined herein for the convenience of the description. Alternate boundaries can be defined so long as the specified functions and relationships thereof are appropriately performed.

The foregoing description of the specific embodiments will so fully reveal the general nature of the invention that others can, by applying knowledge within the skill of the art, readily modify and/or adapt for various applications such specific embodiments, without undue experimentation, without departing from the general concept of the present invention. Therefore, such adaptations and modifications are intended to be within the meaning and range of equivalents of the disclosed embodiments, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance.

The breadth and scope of the present invention should not be limited by any of the above-described exemplary embodiments.

Exemplary embodiments of the present invention have been presented. The invention is not limited to these examples. These examples are presented herein for purposes of illustration, and not limitation. Alternatives (including equivalents, extensions, variations, deviations, etc., of those described herein) will be apparent to persons skilled in the relevant art(s) based on the teachings contained herein. Such alternatives fall within the scope and spirit of the invention.

1.-23. (canceled)

24. A computer-implemented method, comprising:
displaying, on a display device, a list of items including a first item located at a first position and a second item located at a second position;
detecting a speed of an object associated with a movement in a first direction toward the first item; and
moving the second item a distance from the second position to a third position on the display while maintaining the display of the first item at the first position, wherein the distance is based at least on the detected speed.

25. The method of claim 24, wherein the list of items comprises at least one of a block of text, lines of text, or images.

26. The method of claim 24, further comprising:
identifying a maximum distance between the first and second items;
detecting the object on the display device; and
when a distance between the first and second items is less than the maximum distance, moving the second item at the third position a farther distance from the first item based on the object detecting.

27. The method of claim 24, further comprising:
determining that the object is not detected on the display device;
when it is determined that the object is not detected on the display device, moving the second item to the second position on the display; and
after moving the second item, displaying the first item at the first position and the second item at the second position.

28. The method of claim 27, wherein the moving moves the second item at a speed based at least on the detected speed.

29. The method of claim 27, wherein the moving moves the second item at a speed based at least on a density of underlying data in the list.

30. The method of claim 24, wherein the distance is based at least on a number of items in the list, and the moving the second item moves the second item the distance based at least on the number of items in the list.

31. The method of claim 24, wherein the first position is located at a beginning or end of the list.

32. A system, comprising:
a display configured to display a list of items including a first item located at a first position and a second item located at a second position; and
an input device configured to detect a speed of an object associated with a movement in a first direction toward the first item; and
wherein the display is further configured to display the second item moved a distance from the second position to a third position while maintaining the display of the first item at the first position, wherein the distance is based at least on the detected speed.

33. The system of claim 32, wherein the list of items comprises at least one of a block of text, lines of text, or images.

34. The system of 32, wherein the display is configured to display the first item and the second item at a proportionally increased distance based on the detected speed of the object and a number of items in the list.

35. The system of claim 32, wherein when the input device determines that the object is not detected on the display device, the display device is configured to display the first item and the second item at a decreased distance and to display the first item at the first position and the second item at the second position.

36. The system of claim 32, wherein the first distance is based at least on a number of items in the list.

37. The system of claim 32, wherein the first position is located at a beginning or end of the list.

38. The system of claim 32, wherein the object associated with the movement is a finger or a pointing device.

39. A computer storage medium encoded with a computer program, the program comprising instructions that when executed by one or more computers cause the one or more computers to perform operations comprising:
displaying, on a display device, a list of items including a first item located at a first position and a second item located at a second position;
detecting a speed of an object associated with a movement in a first direction toward the first item; and
moving the second item a distance from the second position to a third position on the display while maintaining the display of the first item at the first position, wherein the distance is based at least on the detected speed.

40. The computer storage medium of claim 39, wherein the list of items comprises at least one of a block of text, lines of text, or images.

41. The computer storage medium of claim 39, further comprising:
determining that the object is not detected on the display device;
when it is determined that the object is not detected on the display device, moving the second item to the second position on the display; and
after moving the second item, displaying the first item at the first position and the second item at the second position.

42. The computer storage medium of claim 39, wherein the moving moves the second item at a speed based at least on the detected speed, a density of the underlying data in the list, and a number of items in the list.

43. The computer storage medium of claim 39, wherein the first position is located at a beginning or end of the list.
